(19) United States
(12) Patent Application Publication
(10) Pub. No.: US 2005/0248685 A1
(43) Pub. Date: Nov. 10, 2005

(54) Multidata processing device and method in a wireless terminal

(75) Inventors: Jeong-Wook Seo, Buk-gu (KR); Wei-Jin Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/111,641

(22) Filed: Apr. 21, 2005

(30) Foreign Application Priority Data
Apr. 21, 2004 (KR) 27458/2004

(51) Int. Cl. H04N 5/64

(52) U.S. Cl. 348/376; 348/838

(57) ABSTRACT

Disclosed is a device for processing multidata in a wireless terminal. In the device, a first data device and a second data device generate first data and second data according to a first mode select signal and a second mode select signal, respectively. A data interface connected to the first and second data devices, interfaces data generated by a data device activated by the mode select signal. A multidata processor includes first and second data processors, drives a data device selected in response to the mode select signal, and processes data output from the data interface through its associated data processor. A display displays image data output from the multidata processor. An audio processor reproduces audio data output from the multidata processor.

### PRIORITY

This application claims priority under 35 U.S.C. § 119 to an application entitled “Multidata Processing Device and Method in a Wireless Terminal” filed in the Korean Intellectual Property Office on Apr. 21, 2004 and assigned Serial No. 2004-27458, the contents of which are incorporated herein by reference.

### BACKGROUND OF THE INVENTION

1. Field of the Invention

The present invention relates generally to a data receiving device and method for a wireless terminal, and in particular, to a device and method for interfacing and processing data received from a plurality of devices.

2. Description of the Related Art

In general, current wireless terminals have a separate multimedia processor to strengthen its multimedia function, especially a camera function. Recent developments propose technology for providing television functionality to wireless terminals. In addition, other research has concentrated on equipping satellite broadcast receivers on mobile terminals. Therefore, modern wireless terminals should have an advanced structure capable of supporting various multimedia functions. The growing need for multimedia functions causes an increase in structure and processing capacity of the wireless terminal.

In a wireless terminal with a camera, a camera interface is roughly comprised of a data signal, a sync signal and a clock signal, and among the signals, the sync signal can be set on various conditions. In a wireless terminal with a satellite broadcast receiver, a digital broadcast interface is included with a data signal and an error/valid signal, and on each condition, the data signal is received according to the error/valid signal.

The wireless terminal with the camera and/or the satellite broadcast receiver should be able to perform image processing on data received from its respective devices (i.e., the camera and the satellite broadcast receiver). The wireless terminal should have separate image processing devices for processing images from the camera and from the satellite broadcast receiver. The plurality of image devices and their associated image processing devices increase structural complexity and processing needs.

In the wireless terminal in which various multimedia data is processed, it is possible to simplify a structure and a processing procedure of the wireless terminal by interfacing multidata (received from multiple devices) like single-data (received from a single device) before processing.

### SUMMARY OF THE INVENTION

It is, therefore, an object of the present invention to provide a device and method for interfacing multidata received from a plurality of devices before processing in a wireless terminal.

It is another object of the present invention to provide a device and method for interfacing broadcast data and camera data before processing in a wireless terminal with a digital broadcast receiver and a camera.

It is further another object of the present invention to provide a device and method for selectively interfacing data received from a digital broadcast receiver and a camera using a single interface before processing in a wireless terminal.

It is yet another object of the present invention to provide a device and method for selectively interfacing data received from respective devices in a wireless terminal with a digital broadcast receiver and a camera, and processing the interfaced data using one processor.

It is still another object of the present invention to provide a device and method for synthesizing broadcast data received from a digital broadcast receiver with camera data received from a camera in a wireless terminal with the digital broadcast receiver and the camera.

To achieve the above and other objects, there is provided a device for processing multidata in a wireless terminal, including a camera for generating image data photographed in a camera mode; a digital broadcast receiver for generating digital broadcast data received in a broadcast reception mode; a multidata processor including the camera and the digital broadcast receiver, for changing an output of a device unselected in response to a mode select signal to a high-impedance state, driving a device selected in response to the mode select signal, and processing data output from the selected device through a data processor; a display for displaying image data output from the multidata processor; and an audio processor for reproducing audio data output from the multidata processor.

Preferably, the multidata processor includes a first data processor including a demultiplexer for analyzing, if a first mode is selected, a header of packet data output from the digital broadcast receiver and demultiplexing the packet data into image data and audio data, and a decoder having an image decoder and an audio decoder for decoding the demultiplexed image data and the audio data, respectively; and a second data processor including a scaler for scaling, if a second mode is selected, the data output from the camera in a size of the display.

Preferably, the multidata processor includes an encoder for compression-encoding the photographed image data if a record mode is selected in the camera mode; and a memory for storing the encoded data.

Preferably, the multidata processor includes a memory for storing the encoded digital broadcast data output from the demultiplexer if a record mode is selected in the digital broadcast mode.

Preferably, a clock, a valid signal, an error signal and data of the digital broadcast receiver are connected to clock, horizontal sync signal, vertical sync signal and data input terminals of the multidata processor, respectively; and a clock, a horizontal sync signal, a vertical sync signal and data of the camera are connected to the clock, horizontal sync signal, vertical sync signal and data input terminals of the multidata processor, respectively.

Preferably, a clock and data of the digital broadcast receiver are connected to clock and data input terminals of the multidata processor, respectively; a valid signal of the digital broadcast receiver is connected in common to horizontal and vertical sync signal input terminals of the multidata processor; and, a clock, a horizontal sync signal, a vertical sync signal and data of the camera are connected to the clock, horizontal sync signal, vertical sync signal and data input terminals of the multidata processor, respectively.

Preferably, a clock, a valid signal and data of the digital broadcast receiver are connected to clock, horizontal sync signal and data input terminals of the multidata processor, respectively; a vertical sync signal input terminal of the multidata processor is connected to a camera reset signal; and, a clock, a horizontal sync signal, a vertical sync signal and data of the camera are connected to clock, horizontal sync signal, vertical sync signal and data and data input terminals of the multidata processor, respectively.

Preferably, a clock, a valid signal, an error signal and data of the digital broadcast receiver are connected to clock, valid signal, error signal and data input terminals of the multidata processor, respectively; and a clock, a horizontal sync signal, a vertical sync signal and data of the camera are connected to clock, error signal, valid signal and data input terminals of the multidata processor, respectively.

Preferably, a clock and data of the camera are connected to clock and data input terminals of the multidata processor, respectively; a horizontal sync signal and a vertical sync signal of the camera are connected in common to a valid signal input terminal of the multidata processor; and, a clock, a valid signal, an error signal and data of the digital broadcast receiver are connected to clock, valid signal, error signal and data input terminals of the multidata processor, respectively.

Preferably, a clock, a valid signal, an error signal and data of the digital broadcast receiver are connected to clock, valid signal, error signal and data input terminals of the multidata processor, respectively; a vertical sync signal input terminal of the multidata processor is connected to a camera reset signal; and, a clock, a horizontal sync signal and data of the camera are connected to clock, valid signal and data input terminals of the multidata processor, respectively.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a structure of a mobile phone according to an embodiment of the present invention;

FIG. 2 is a diagram illustrating a structure of a mobile phone according to an alternative embodiment of the present invention;

FIG. 3 is a diagram illustrating an internal structure of the multidata processor of FIG. 2;

FIG. 4 is a diagram illustrating a structure of the data interface of FIGS. 1 and 2 according to an embodiment of the present invention;

FIG. 5 is a diagram illustrating an internal structure of a multidata processor including the data interface of FIG. 4 according to an embodiment of the present invention;

FIGS. 6A and 6B are diagrams illustrating operation timing for interfacing an output of a camera according to an embodiment of the present invention;

FIGS. 7A and 7B are diagrams illustrating operation timing for interfacing an output of a digital broadcast receiver according to an embodiment of the present invention;

FIGS. 8A to 8F are diagrams illustrating possible connections between a digital broadcast receiver, a camera, and a multidata processor according to an embodiment of the present invention;

FIG. 9 is a diagram illustrating a structure of a data interface for interfacing digital broadcast data and camera data according to an embodiment of the present invention;

FIG. 10 is a flowchart illustrating a procedure for processing multidata in a mobile phone according to an embodiment of the present invention;

FIG. 11 is a flowchart illustrating the procedure for processing the camera data in FIG. 10; and

FIG. 12 is a flowchart illustrating the procedure for processing the digital broadcast data in FIG. 10.

### DETAILED DESCRIPTION OF THE PREFERRED EMBODIMENT

A preferred embodiment of the present invention will now be described in detail with reference to the annexed drawings. In the drawings, the same or similar elements are denoted by the same reference numerals even though they are depicted in different drawings.

In the following description, specific details such as output signals of a camera and output signals of a digital broadcast receiver are defined for a better understanding of the present invention. However, it would be obvious to those skilled in the art that the invention could be simply implemented without the specific details or with modification thereof.

The present invention proposes a device and method for processing selected multidata with one processor in a wireless terminal having a plurality of devices. In particular, the present invention proposes a device and method for interfacing multidata received in similar data formats into single-format data before processing. For example, in a wireless terminal with a camera and a digital broadcast receiver, data output of the digital broadcast receiver is similar in format to data output of the camera. A camera interface roughly includes a data signal, a sync signal and a clock signal, and among the signals, the sync signal can be set on various conditions. A digital broadcast interface roughly includes a data signal, an error/valid signal and a clock signal. According to an embodiment of the present invention, the wireless terminal connects the error/valid signal of the digital broadcast interface with the sync signal of the camera interface and performs software manipulation to transmit data.

In addition, the present invention proposes a wireless terminal with a digital broadcast receiver and a camera in which data generated from the two devices is selectively processed through a single interface. The camera and the digital broadcast receiver, when connected to each other, can undergo time division-based concurrent processing. Herein, a description will be made of a connection between two modules (i.e., a camera and a digital broadcast receiver) and a displaying method of a wireless terminal according to an embodiment of the present invention.

The wireless terminal according to an embodiment of the present invention may include a mobile phone, a Personal Digital Assistant (PDA), a smart phone, etc. It will be assumed herein that the wireless terminal is a mobile phone.

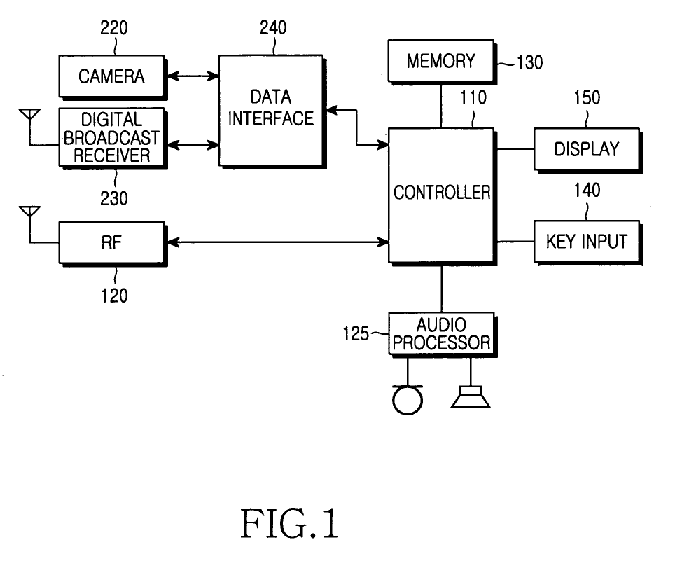

FIG. 1 is a diagram illustrating the structure of a mobile phone according to an embodiment of the present invention. In FIG. 1, the mobile phone does not have a separate multimedia processing controller. Instead, a controller 110, which is an MSM (Mobile Station Modem) chip, includes, not only an overall control function for the mobile phone, but also a function for processing camera image data received from a camera 220 and digital broadcast data received from a digital broadcast receiver 230.

Referring to FIG. 1, a radio frequency (RF) unit 120 performs radio communication functions for the mobile phone. The RF unit 120 includes an RF transmitter for up-converting a transmission signal frequency and amplifying the up-converted transmission signal, and an RF receiver for low-noise-amplifying a received signal and down-converting the low-noise-amplified signal frequency.

The controller 110, which controls the overall operation of the mobile phone, processes transmission/reception voice and data, camera image data output from the camera 220, and broadcast data output from the digital broadcast receiver 230.

To process communication data, the controller 110 includes a transmitter for encoding and modulating a transmission signal and a receiver for demodulating and decoding a reception signal. That is, the controller 110 can include a data processor comprised of a modem and a codec. Herein, the data processor can process channel data using a Code Division Multiple Access (CDMA) scheme, a Universal Mobile Telecommunications System (UMTS) scheme, or Global System for Mobile communication (GSM) scheme. The controller 110 controls an audio processor 125 to reproduce received audio signals output from its internal audio codec or to process a transmission audio signal generated from a microphone using the audio codec before transmission. Herein, the data processor can be separated from the controller 110 and implemented on an independent basis. In addition, the controller 110 can include a multidata processor for processing multidata output from the camera 220 and the digital broadcast receiver 230.

A key input unit 140 includes alphanumeric keys for inputting alphanumeric information, and function keys for setting various functions. According to the present invention, the key input unit 140 can generate a mode switch command (to a camera mode or a broadcast reception mode) so as to selectively process the camera image data from the camera 220 and the broadcast data from the digital broadcast receiver 230.

The memory 130 may include program memory and data memory. The program memory includes programs for controlling general operation of the mobile phone and programs for processing a selected one of camera data and digital broadcast data according to an embodiment of the present invention. The data memory may include non-volatile memory (NVM) for storing non-volatile data (e.g., bitmap data, font data, and phone book data) and a random access memory (RAM) for temporarily storing data generated in the execution of the programs.

A display 150, under the control of the controller 110, displays operating information of the mobile phone, and also displays a selected one of the camera data from the camera 220 and the digital broadcast data from the digital broadcast receiver 230.

The camera 220, under the control of the controller 110, photographs in a camera mode an image and processes the photographed image into a digital image signal. The camera 220 may include a camera lens, a sensor (Complementary Metal-Oxide Semiconductor (CMOS) sensor or Charge-Coupled Device (CCD) sensor), and a signal processor for converting an analog image into a digital signal. Signals output from the camera 220 can include image data, horizontal/vertical sync signals, and a clock signal.

The digital broadcast receiver 230, under the control of the controller 110, receives in a broadcast reception mode a broadcast signal for a selected channel and decodes the received digital broadcast signal. The digital broadcast receiver 230 may include a tuner for selecting a broadcast channel under the control of the controller 110 and a demodulator for demodulating a broadcast signal for the selected channel. Signals output from the digital broadcast receiver 230 can include received broadcast data, an error/valid signal and a clock signal. Herein, the broadcast can include satellite broadcast and terrestrial broadcast, and the broadcast signal can be a digital broadcast signal.

A data interface 240, under the control of the controller 110, selects an output of the camera 220 or an output of the digital broadcast receiver 230, converts the selected signal into a data format for the controller 110, and outputs the converted signal to the controller 110 after buffering.

In the foregoing manner, the mobile phone can process data received from several devices, one of which is selected by a user, using the same interface. Herein, output terminals of the several devices are combined such that data output formats of the several devices should be equal to each other.

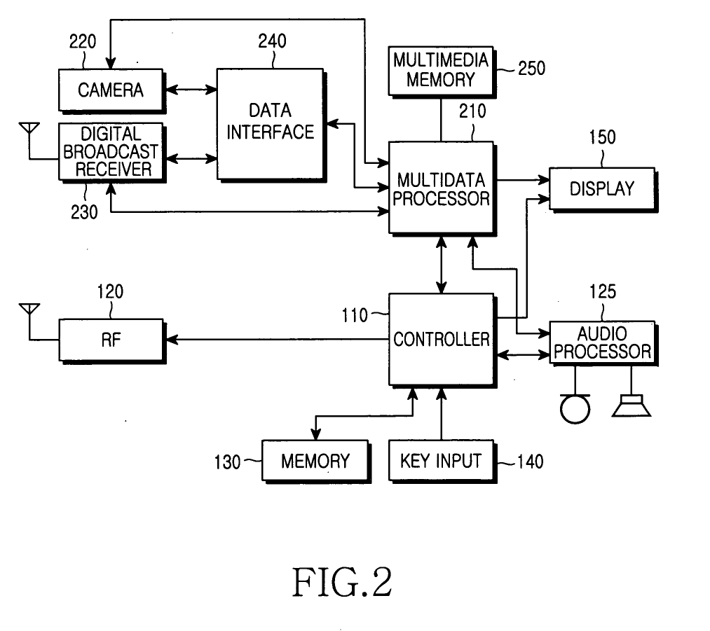

FIG. 2 is a diagram illustrating a structure of a mobile phone according to an alternative embodiment of the present invention. In FIG. 2, the mobile phone has a separate multidata processor 210. Therefore, a controller 110 controls an overall control/communication function for the mobile phone, and the multidata processor 210 includes a function of processing camera image data received from a camera 220 and digital broadcast data received from a digital broadcast receiver 230.

The structure of FIG. 2 is equal to the structure of FIG. 1 except for the inclusion of the multidata processor 210. In the structure of FIG. 2, the controller 110 controls the overall operation of the mobile phone, and a control and data processing function for the camera 220 and the digital broadcast receiver 230 is performed by the multidata processor 210.

Upon receiving a command designating a camera mode or a broadcast reception mode from the controller 110, the multidata processor 210 controls an operation of a corresponding device according to the designated mode while processing received data, and displays the processing result on a display 150.

If the camera mode is designated, the multidata processor 210 drives the camera 220, processes an image signal generated from the camera 220 and displays the processing result on the display 150. To process a signal output from the camera 220, the multidata processor 210 can include a color converter for converting a color of a received image signal (e.g., converting a YUV signal into an RGB signal in the case where the display 150 displays an RGB signal and the camera 220 generates an YUV signal), a scaler (for converting a size of an image signal received from the camera 220 into a size of a screen displayed on the display 150 in the case where the image signal output from the camera 220 is different in size from the screen of the display 150), a thumb-nail image generator, and a codec (Joint Photographic Experts Group (JPEG) and/or Moving Picture Experts Group (MPEG) codec(s) for compressing an image signal before storing the photographed image signal).

If the broadcast reception mode is designated, the multidata processor 210 drives the digital broadcast receiver 230, processes an image signal generated from the digital broadcast receiver 230 and displays the processing result on the display 150. To process a signal output from the digital broadcast receiver 230, the multidata processor 210 includes a channel selection data generator for selecting a channel of the digital broadcast receiver 230, a demultiplexer for demultiplexing received packet data into audio, video and broadcast information data, and audio, video and data decoders for decoding the demultiplexed audio, video and broadcast information data, respectively.

The camera 220, under the control of the multidata processor 210, takes photographs in camera mode and processes the photographed image into a digital image signal. The camera 220 may include a camera lens, a sensor (CMOS sensor or CCD sensor), and a signal processor for converting an analog image into a digital signal. Signals output from the camera 220 can include image data, horizontal/vertical sync signals, and a clock signal.

The digital broadcast receiver 230, under the control of the multidata processor 210, receives, in a broadcast reception mode, a broadcast signal for a designated channel and decodes the received digital broadcast signal. The digital broadcast receiver 230 may include a tuner for selecting a broadcast channel under the control of the controller 110 and a demodulator for demodulating a broadcast signal for the selected channel. Signals output from the digital broadcast receiver 230 can include received broadcast data, an error/valid signal and a clock signal.

A data interface 240, under the control of the multidata processor 210, selects an output of the camera 220 or an output of the digital broadcast receiver 230, converts the selected signal into a data format for the multidata processor 210, and outputs the converted signal to the controller 110 after buffering.

As described above, the mobile phone includes the multidata processor 210, and the multidata processor 210 has a function capable of processing multidata received from multiple devices. In this manner, the mobile phone can process multidata received from multiple devices, one of which is selected by the user, using the same interface. Herein, output terminals of the multiple devices are combined such that data output formats of the multiple devices should be equal to each other.

In the following description, it will be assumed that the mobile phone has the structure of FIG. 2 and the multidata processor 210 has a function of processing multidata output from the camera 220 and the digital broadcast receiver 230.

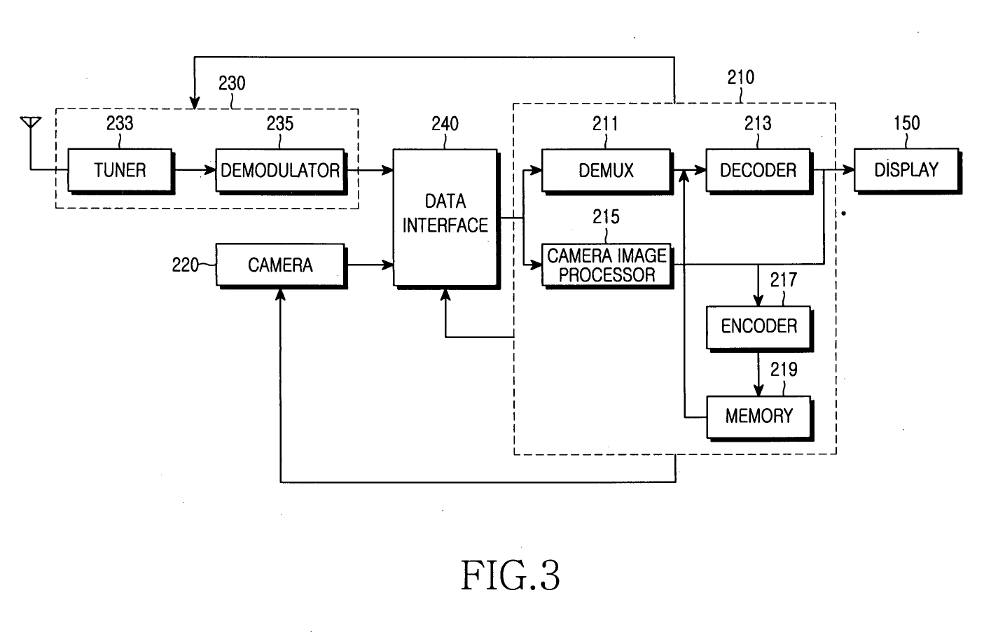

FIG. 3 is a diagram illustrating an internal structure of the multidata processor 210. Referring to FIG. 3, the multidata processor 210 including an undepicted multidata controller sets the camera mode and the broadcast reception mode according to mode selection by the user. If the camera mode is selected, the multidata processor 210 drives the camera 220 and instructs the data interface 240 to select an output of the camera 220. Then the data interface 240 selects image data output from the camera 220 and buffers the camera image data in a data format for a camera image processor 215 in the multidata processor 210. Then the camera image processor 215 scales up or scales down the camera image data in a size of the display 150, and performs color conversion on the scaled-up/down camera image data (e.g., converts YUV data into RBG data). If the user inputs a camera image save command, the image data output from the camera image processor 215 is stored in a memory 219 after being compression-encoded by an encoder 217. Optionally, the memory 219 can be external to the multidata processor 210.

If the broadcast reception mode is selected, the multidata processor 210 drives the digital broadcast receiver 230 and instructs the data interface 240 to select an output of the digital broadcast receiver 230. At the same time, the multidata processor 210 controls a tuner 233 to select a channel desired by a user, and controls a demodulator 235 to demodulate a broadcast signal for the selected channel. A demultiplexer 211 analyzes packets having a program identifier (PID) for the selected channel, demultiplexes the analyzed packets into video, audio and broadcast information data, and outputs the demultiplexed result to a decoder 213. The decoder 213 includes video, audio and data decoders for decoding the demultiplexed video, audio and data broadcast information data, respectively, and the display 150 displays the data decoded by the decoder 213.

Herein, a separate multidata chip for exclusively processing multidata in a mobile phone can be used for the multidata processor 210. Currently, many manufacturers make the multidata chip. In the following description, it is assumed that the multidata processor 210 is implemented with an OMAP 16xx or 18xx-series processor (for example, OMAP1610 processor).

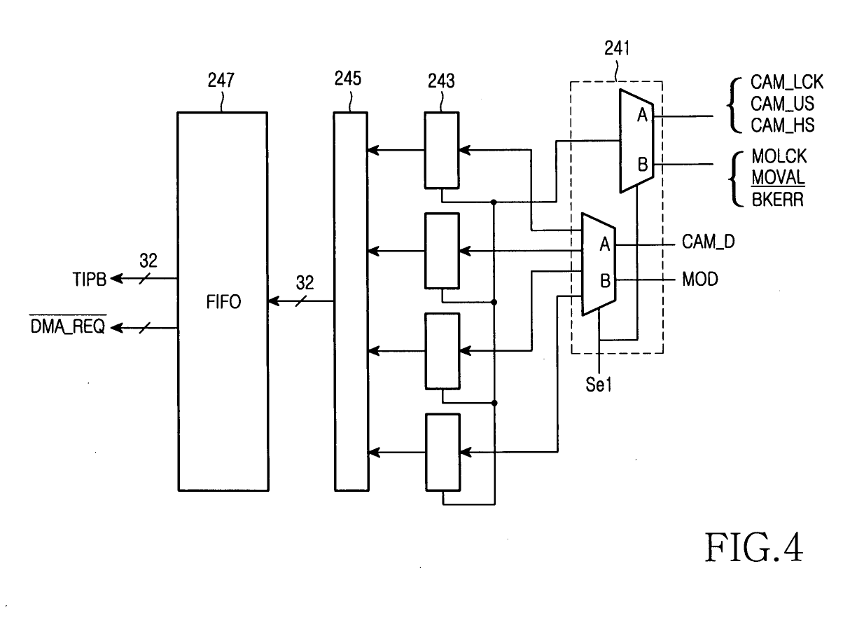

FIG. 4 is a diagram illustrating a structure of the data interface 240 according to an embodiment of the present invention. Referring to FIG. 4, a selector 241 receives control signals “CAM_LCK”, “CAM_US”, “CAM_HS” and data “CAM_D” output from the camera 220 at a first terminal A, and receives control signals “MOLCK”, “MOVAL”, “/BKERR” and data “MOD” output from the digital broadcast receiver 230 at a second terminal B. The selector 241 selects an output of the camera 220, input to the first terminal A, or an output of the digital broadcast receiver 230, input to the second terminal B, depending on a mode select signal “Sel” output from the multidata processor 210. In this way, the selector 241 serves to select data for the mode selected by the user.

The data output from the camera 220 and the digital broadcast receiver 230 can be different from the data processed in the multidata processor 210 in terms of size, or number of bits. In this case, a first buffer 243 and a second buffer 245 are used for bit matching.

For example, if the camera 220 and the digital broadcast receiver 230 process data per byte and the multidata processor 210 processes data per 32 bits, then the first buffer 243 is implemented with four 8-bit data buffers and the second buffer 245 is implemented with a 32-bit buffer. As a result, 8-bit data streams received at the selector 241 are sequentially stored in the four 8-bit data buffers 243 according a control signal output from the selector 241, and the second buffer 245 delivers 32-bit data fully buffered in the first buffer 243 to a First-In First-Out buffer (FIFO) 247. Herein, the first buffer 243 and the second buffer 245 constitute a data conversion unit for performing data conversion.

The FIFO buffer 247 buffers data buffered in the second buffer 245 into data with a predetermined size, and delivers the result to the multidata processor 210. For the data output from the camera 220, the FIFO 247 serves as a line buffer. Therefore, in camera mode, the multidata processor 210 drives the FIFO buffer 247 as a line buffer and buffers camera image data per line. However, in the broadcast reception mode, the multidata processor 210 drives the FIFO buffer 247 as a packet buffer and buffers digital broadcast data per packet. Herein, one packet is 188 bytes.

To sum up, the data interface 240 may include a selection unit for selecting multimedia data for a selected mode among signals output from multiple devices, a data conversion unit for converting a size of the received multimedia data into a size of data processed in the multidata processor 210, and a buffer unit for buffering the size-converted data into a data format for the multidata processor 210.

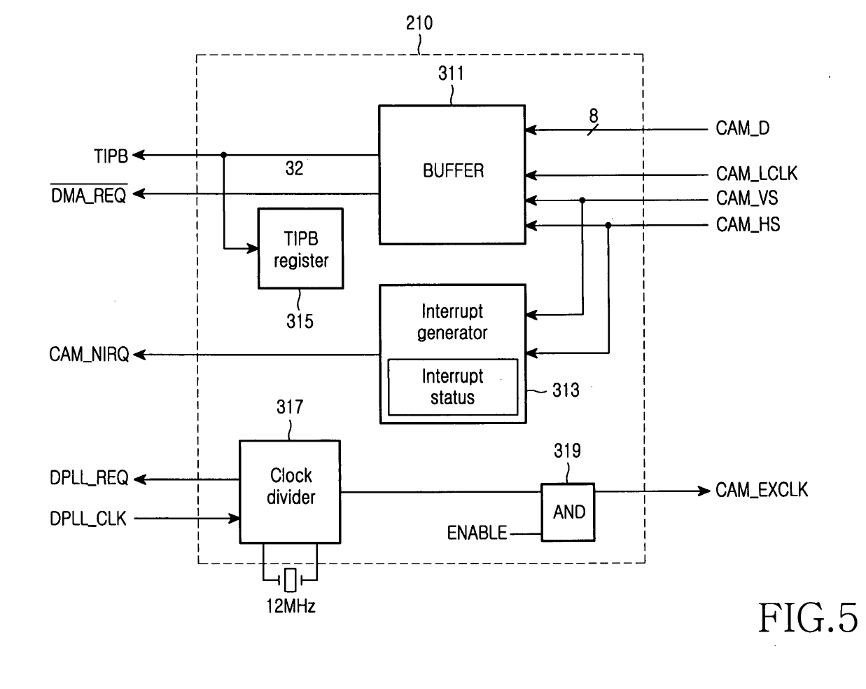

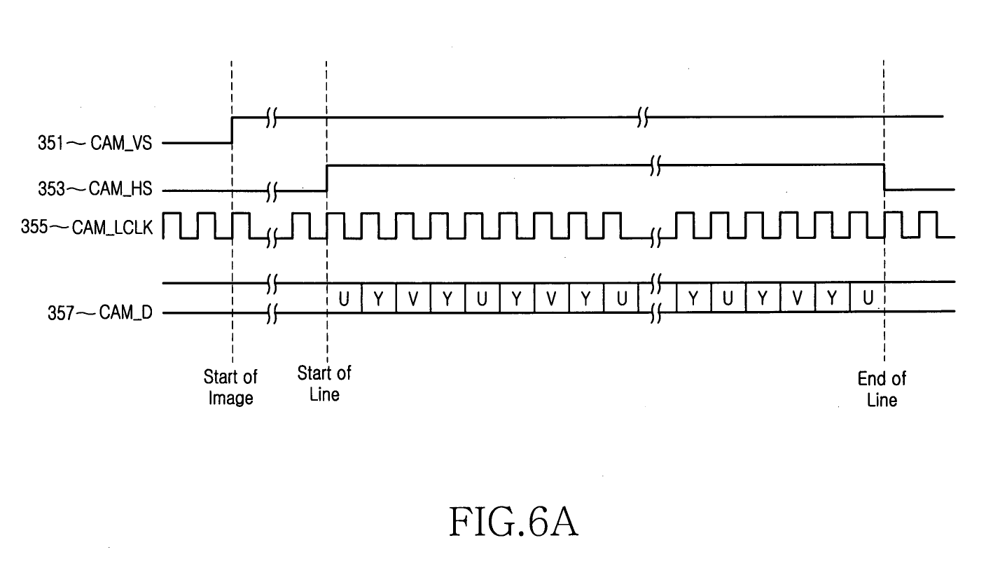

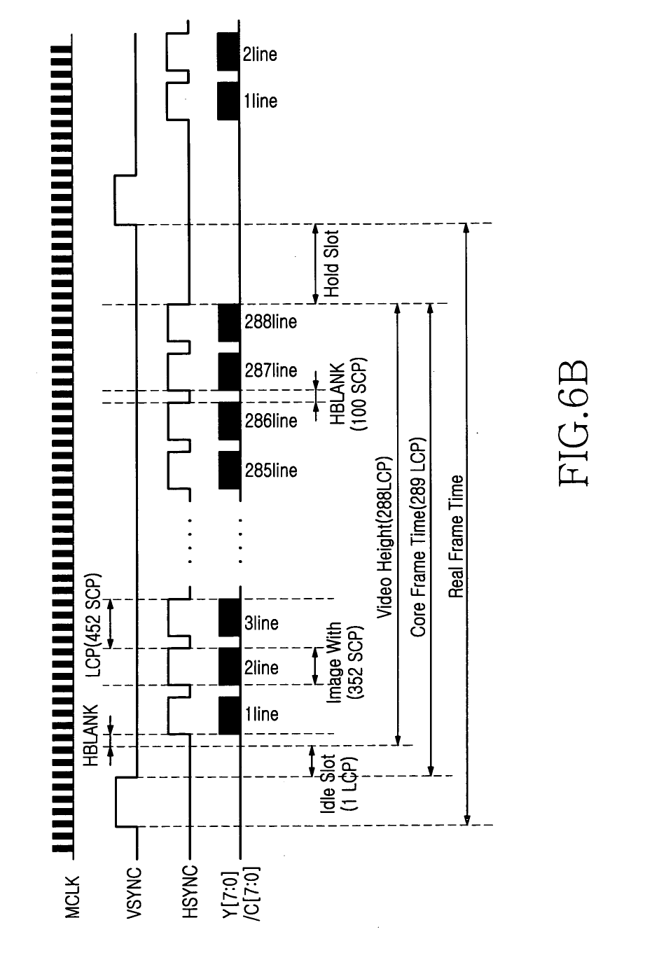

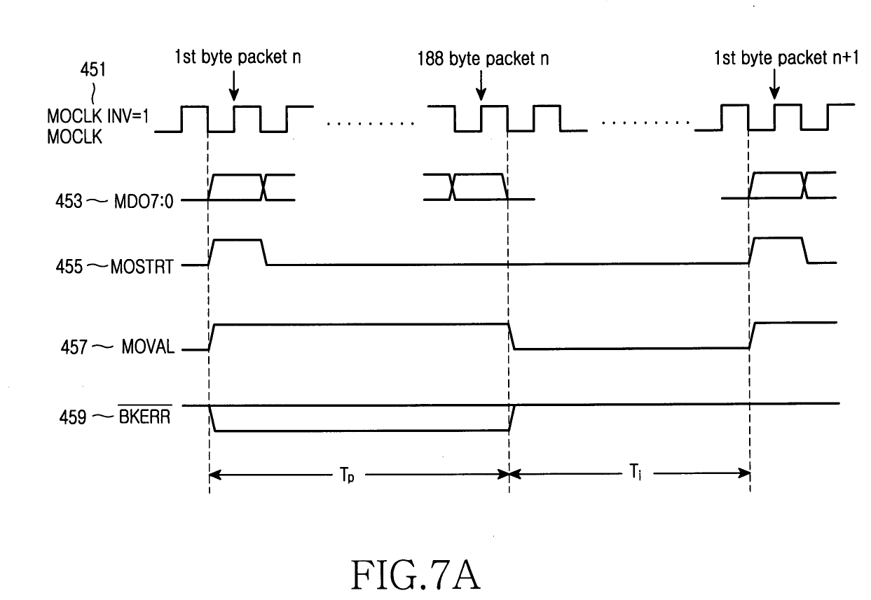

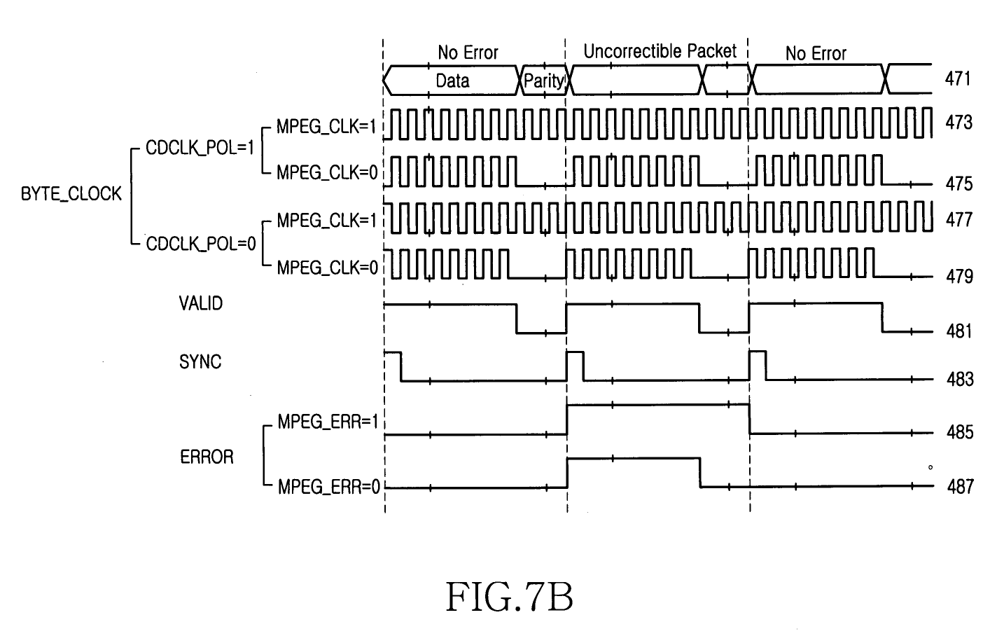

FIG. 5 is a diagram illustrating an internal structure of the multidata processor 210 including the buffers 243 to 247 in the data interface 240 of FIGS. 3 and 4 according to an embodiment of the present invention. FIGS. 6A and 6B are diagrams illustrating operation timing for interfacing an output of the camera 220, and FIGS. 7A and 7B are diagrams illustrating operation timing for interfacing an output of the digital broadcast receiver 230.

The structure of FIG. 5 will be described with reference to the operation timing illustrated in FIGS. 6A and 6B. An interface for the camera 220 may include data, a control signal, and a clock signal. In FIG. 5, “CAM_D” represents an 8-bit data bus. A clock signal “CAM_LCLK” is used for synchronized data transmission. A vertical sync signal “CAM_VS” and a horizontal sync signal “CAM_HS” are used for distinguishing information on a I-line image signal and a 1-frame image signal in an image signal output from the camera 220. The multidata processor 210 can reproduce line and frame images for a received image signal according to the sync signals.

The “CAM_VS” and the “CAM_HS” become data processing units in the multidata processor 210. For each case, the multidata processor 210 generates an interrupt signal, and processes an image received from the camera 220 according to the interrupt signal. Because a vertical sync signal Vsync and a horizontal sync signal Hsync undergo level-triggering, rising-triggering or falling-triggering according to the camera module, the multidata processor 210 is designed to select one of the triggering types.

The received 8-bit camera image data, to be connected to a 32-bit bus, is cconverted into 32-bit data (8 bit to 32 bit conversion), and then delivered to the multidata processor 210 after being buffered in a FIFO buffer per line or per frame. Because the multidata processor 210 is a 32-bit processor, the data interface 240 converts 8-bit data into 32-bit data, and buffers the converted data using a buffer 311 such that the multidata processor 210 can process image data per line or per frame. Thereafter, the multidata processor 210 processes the received image data, and displays the processing result on the display 150 or stores the processing result in a memory 250. A clock generated from a clock generator 317 is ANDed with an enable signal in an AND gate 319, generating a data clock in an interval where the enable signal is activated.

Referring to FIG. 6A, a vertical sync signal CAM_VS (351) is a high-active signal that is enabled for an interval where a frame image is generated by the camera 220, and a horizontal sync signal CAM_HS (353) is a high-active signal that is enabled for an interval where a line image is generated by the camera 220. A data clock CAM_LCLK (355) is a clock for transmitting pixels of an image photographed by the camera 220. Therefore, the vertical sync signal 351 is enabled when a frame image signal is generated, and the horizontal sync signal 353 is enabled when a line image signal is generated. Data CAM_D (357) of an image photographed by the camera 220 is applied to the buffer 311 according to the data clock CAM_LCLK (355) generated for an interval where the two sync signals 351 and 353 are both enabled. Herein, the buffer 311 can include the first buffer 243, the second buffer 245 and the FIFO buffer 247 of FIG. 4. In this case, the first buffer 243 is enabled by the sync signals 351 and 353, and generated image data U,Y,V,Y,U,Y . . . (357) is sequentially stored in the first buffer 243 per 8 bits. The second buffer 245 buffers output data of the first buffer 243 per 32 bits. The FIFO 247 delivers a fully-buffered line image to the multidata processor 210.

FIG. 6B is a timing diagram illustrating a line image interval and a frame image interval when the camera 220 uses a CMOS sensor.

With reference to FIGS. 7A and 7B, a description will now be made of an operation of processing a digital broadcast signal. In the broadcast reception mode, the tuner 233 generates a digital broadcast signal for a channel selected by a user, and frequency-down-converts the digital broadcast signal into a baseband signal. The demodulator 235 demodulates the modulated digital broadcast signal output from the tuner 233 into its original signal. Signals output from the demodulator 235 are illustrated in FIGS. 7A and 7B. The demodulated digital broadcast signals output from the demodulator 235 are demultiplexed by a demultiplexer 211, and displayed on the display 150 after being decoded by the decoder 213.

Herein, the tuner 233 and the demodulator 235 constitute the digital broadcast receiver 230, and the demultiplexer 211 and the decoder 213 are arranged in the multidata processor 210. Optionally, the decoder 213 can be implemented by software or hardware in the multidata processor 210. The received digital broadcast data can be displayed on the display 150 or stored in the memory 219.

With reference to FIG. 7A, a description will be made of an operation in which the multidata processor 210 outputs the signal demodulated by the demodulator 235. FIG. 7A is a timing diagram illustrating output characteristics of an MT352 demodulator manufactured by Zalink Co. Output signals of the MT352 demodulator include 8-bit data, a clock signal, and control signals MOSTRT, MOVAL and /BKERR.

The demodulator 235 demodulates received packet data, and then determines whether the demodulation is successful. If the demodulation is successful, the demodulator 235 high-activates a valid signal MOVAL (457) indicating the successful demodulation, and if the demodulation fails, the demodulator 235 low-activates an error signal /BKERR (459) indicating the failure. At a start of a packet, the demodulator 235 generates a MOSTRT signal 455 indicating the start of the packet. As a result, if the MOSTRT signal 455 is generated and the valid signal MOVAL (457) is high-activated, the demodulator 235 outputs a demodulated digital broadcast signal MDO7:0 (453) to the demultiplexer 211 in the multidata processor 210 according to the clock MOCLK (451). However, if the error signal /BKERR (459) is low-activated indicating that the demodulated digital broadcast signal is a demodulation-failed signal, the demodulated digital broadcast signal is blocked from the demultiplexer 211.

With reference to FIG. 7B, a description will now be made of an operation in which the multidata processor 210 outputs the signal demodulated by the demodulator 235. FIG. 7B is a timing diagram illustrating output characteristics of a PN2020 demodulator. Output signals of the PN2020 demodulator include 8-bit data, clock signals, and control signals VALID, SYNC and ERROR.

Referring to FIG. 7B, if a received packet is normally demodulated, the demodulator 235 generates a valid signal VALID (481) indicating the normal demodulation. However, if an error occurs in the process of demodulating the received packet, the demodulator 235 generates high-active error signals ERROR (485 and 487). As illustrated in FIG. 7B, data 471 synchronized with the clock is transmitted to the multidata processor 210 for an interval where the error signal is low-inactivated, and the demodulated data 471 is processed as an uncorrectable packet for an interval where the error signal is high-activated.

It can be understood from the signal characteristics of FIGS. 6A and 6B and FIGS. 7A and 7B that an output signal of the camera 220 may include a clock, data and control signals “CAM_VS” and “CAM_HS”, and an output signal of the digital broadcast receiver 230 may include a clock, data and control signals “VALID” and “ERROR”. As a result, an output signal of the multidata processor 210 is also comprised of a clock, data and control signals. In this case, an output of the camera 220 is similar to an output of the digital broadcast receiver 230 in terms of the signal characteristics. That is, the output of the camera 220 is equal to the output of the digital broadcast receiver 230 in terms of a format of the data and the clock. Therefore, if the control signals are appropriately connected, the multidata processor 210 can receive the signals input both in the camera mode and the broadcast reception mode, at the same input terminals.

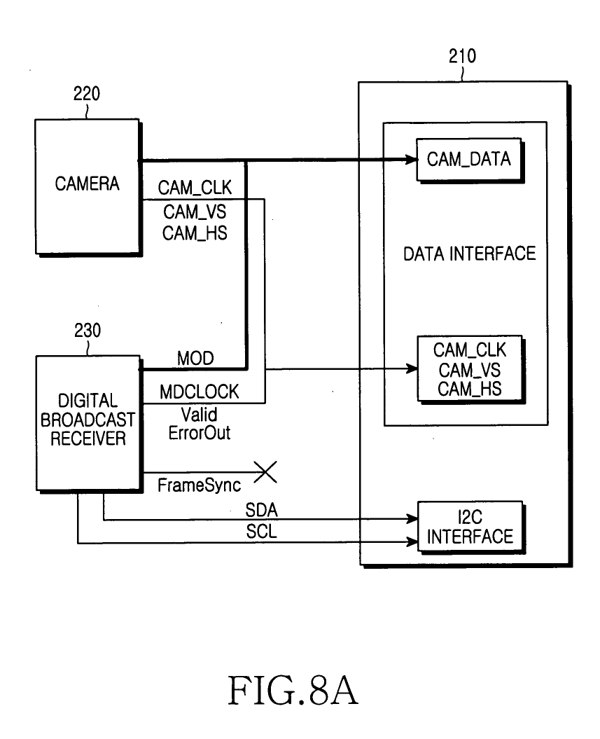

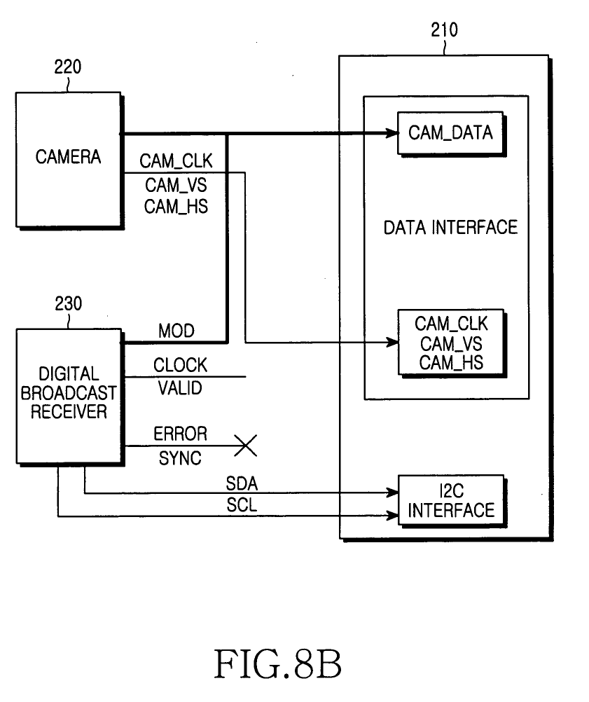

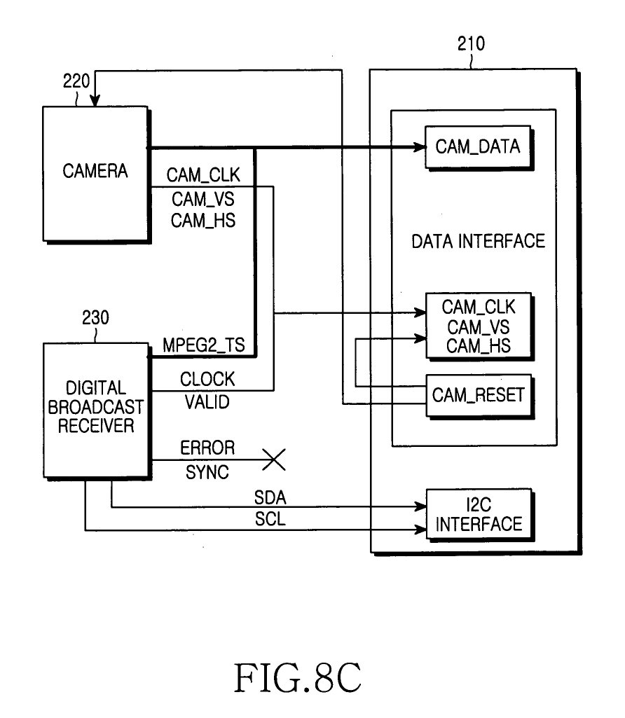

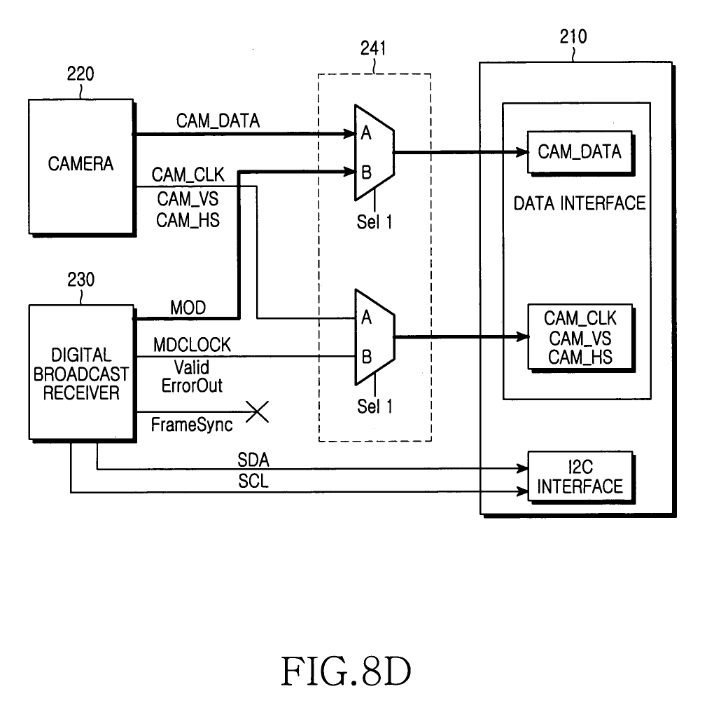

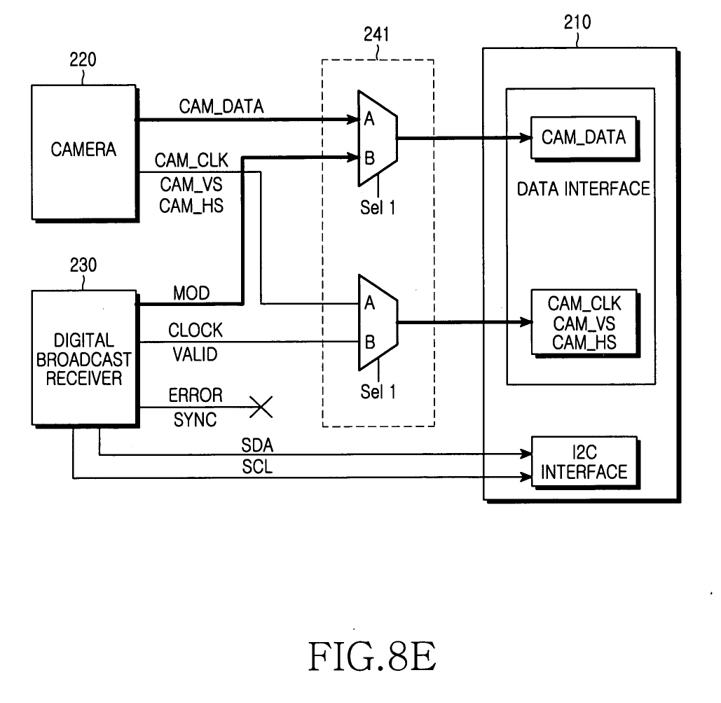

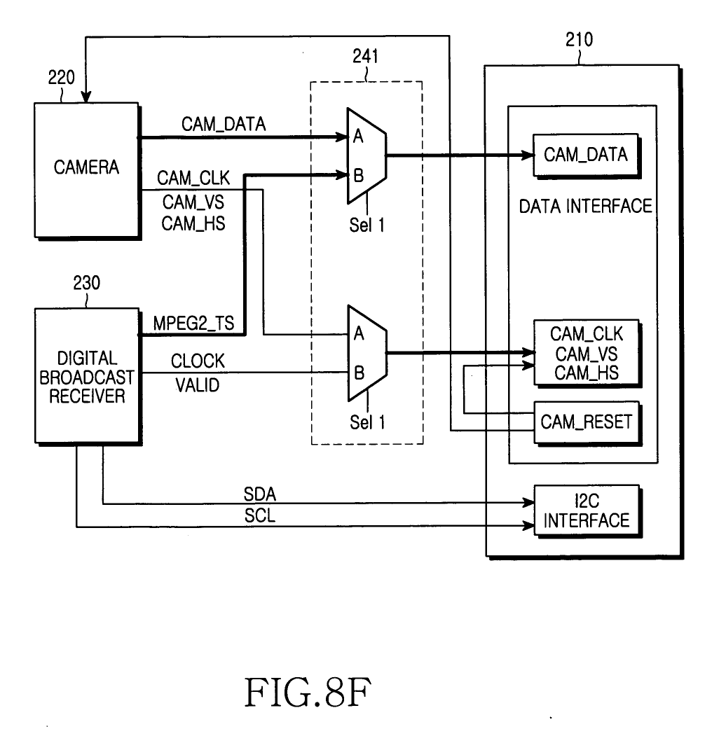

FIGS. 8A to 8F are diagrams illustrating different structures of the data interface 240 for interfacing multidata (herein, including camera data and digital broadcast data) according to alternative embodiments of the present invention. In FIGS. 8A to 8F, the data interface 240 is arranged in the multidata processor 210. As described above, the multidata processor 210 can be implemented with the OMAP1610 processor. The data interface 240 illustrated in FIGS. 8A to 8C does not use the selector 241 illustrated in FIG. 4. Instead, output terminals of an unselected device change to a high-impedance state, preventing interference to output signals of the other device. For example, if the camera 220 is selected, outputs of the digital broadcast receiver 230, i.e., a clock, a valid signal, an error signal and data, are maintained at the high-impedance state, preventing interference to outputs of the camera 220. In the same manner, if the digital broadcast receiver 230 is selected, output signals of the camera 220 are maintained at the high-impedance state.

Referring to FIG. 8A, it is assumed that the demodulator 235 is implemented with MT352 and the multidata processor 210 is implemented with OMAP1610. Herein, because MOD 0-7 of the MT352 demodulator is an 8-bit bus through which MPEG TS data is delivered, it can be connected to “CAM_DATA” of the OMAP1610 multidata processor, and “MDCLOCK”, which is the data and clock sync clock of MT352, can be connected to “CAM_CLK” of OMAP1610. The MOVAL (Valid) signal 457 of FIG. 7A indicates that the data is valid, and the /BKERR (/ErrorOut) signal 459 maintains a logic High state in a normal state (where demodulation is normally performed) and changes to a logic Low state when the packet ends or an error occurs during packet demodulation.

Based on the characteristics of the control signals MOVAL and /BKERR, a triggering type of “CAM_VS” and “CAM_HS” is set to falling-edge-triggering and data is received only in an interval Valid where normal demodulation is performed. In this manner, the data generated in an interval where a demodulation error occurs can be simply discarded. Herein, SCL and SDA of the multidata processor 210 mean a general 1²C interface, and can be used for channel setup.

In FIG. 8A, if the broadcast reception mode is selected, the multidata processor 210 inactivates the camera image processor 215, activates the demultiplexer 211 and the decoder 213, and controls the camera 220 to change its outputs (“CAM_DATA”, “CAM_CLK”, “CAM_VS”, “CAM_HS”) to the high-impedance state. In addition, a clock “MDCLOCK”, a valid signal “Valid” and an error signal “ErrorOut” of the digital broadcast receiver 230 are connected to “CAM_CLK”, “CAM_VS” and “CAM_HS” terminals of the multidata processor 210, respectively, and data “MOD” is connected to a “CAM_DATA” terminal. Therefore, broadcast data received from the digital broadcast receiver 230, outputs of which are connected to the multidata processor 210, is processed in the multidata processor 210. However, if the camera 220 is selected, the multidata processor 210 activates the camera image processor 215, inactivates the demultiplexer 211 and the decoder 213, and controls the digital broadcast receiver 230 to change its outputs to the high-impedance state. The outputs of the camera 220 are interfaced to the multidata processor 210, and the multidata processor 210 processes the data output from the camera 220.

Referring to FIG. 8B, in the demodulator 235 is implemented with a PN2020 demodulator having the signal characteristics of FIG. 7B. Error signals 485 and 487 have a logic Low state when there is no demodulation error. The PN2020 demodulator has the opposite logic to that of the MT352 demodulator having the error signal characteristics of FIG. 7A. However, because a camera interface can interchangeably set High logic and Low logic for Vsync and Hsync on a default basis, either modulator can be used with the corresponding setting in the camera interface.

Because a valid signal of the PN2020 demodulator is similar to a valid signal of the MT352 demodulator and can be set in the same manner, the valid signal can be directly connected to two pins “CAM_VS” and “CAM_HS” as illustrated in FIG. 8B. The foregoing connection method can be used even when setting for Vsync and Hsync cannot be changed.

Generally, the camera 220 has the output characteristics illustrated in FIG. 6B. The camera 220 having the output characteristics of FIG. 6B corresponds to an HV7121 CMOS image sensor module made by Hynix Co., which includes MCLK, Vsync, Hsync, and Y[7:0]/C[7:0]. The Y[7:0]/C[7:0] represents 8-bit data. A horizontal sync signal Hsync is used as a reference signal for each line image, and a vertical sync signal Vsync is used as a reference signal for each frame image. Therefore, if the camera mode is selected, the multidata processor 210 changes outputs of the digital broadcast receiver 230 to the high-impedance state and processes the image data output from the camera 220.

FIG. 8C is diagram illustrating another structure of a digital broadcast receiver and a camera interface, in which a valid signal is connected to a horizontal sync terminal of the camera interface and a CAM_RESET terminal is connected to a vertical sync terminal of the camera interface. Therefore, a signal applied to the horizontal terminal of the camera interface is active-high while the camera is inactivated. As a result, the structure of FIG. 8C is inactive while the camera operates. However, while the camera is inactive, broadcast data processed by the digital broadcast receiver is delivered to the camera interface according to a state of the valid signal.

In operation, if the broadcast reception mode is set, outputs of the camera 220 are changed to the high-impedance state by a camera reset signal CAM_RESET, and the tuner 233 and the demodulator 235 are activated setting a state where the digital broadcast data can be received. At this time, if the valid signal is activated, broadcast data received through a data port is delivered to the multidata processor 210. No data is delivered to the data port for an interval where the valid signal is inactive. The valid signal is inactive after the data is transmitted for a predetermined time. However, if the camera mode is selected, the multidata processor 210 sets outputs of the digital broadcast receiver 230 to the high-impedance state, and releases the camera reset signal to activate the camera 220. Then, a clock, a horizontal sync signal and a vertical sync signal of the camera 220 are connected to their associated input terminals of the multidata processor 210, and camera data is also connected to a data input terminal of the multidata processor 210.

FIGS. 8D to 8F are similar to FIGS. 8A to 8C in structure except that the selector 241 is connected between the output terminals of the camera 220 and the digital broadcast receiver 230 and the input terminals of the multidata processor 210. Therefore, in FIGS. 8D to 8F, it is not necessary to maintain outputs of the unselected device at the high-impedance state. That is, the selector 241 has input terminals A connected to output terminals of the camera 220 and input terminals B connected to output terminals of the digital broadcast receiver 230, and delivers outputs of a selected device to the multidata processor 210.

FIGS. 8A to 8F illustrate examples in which the multidata processor 210 has input terminals (clock, horizontal/vertical signal, and data terminals) corresponding to output terminals of the camera 220. However, the data interface 240 can be implemented in the same manner even though the multidata processor 210 has input terminals (clock, valid signal, error signal, and data terminals) corresponding to output terminals of the digital broadcast receiver 230.

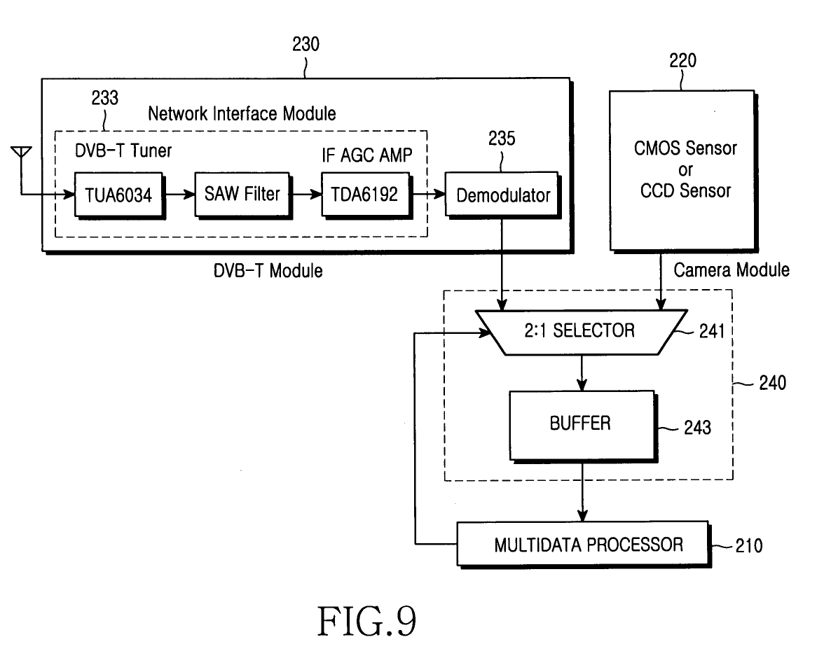

FIG. 9 is a diagram illustrating a structure of a data interface 240 according to a further alternative embodiment of the present invention. FIG. 9 illustrates an example in which a multidata processor 210 does not include a data interface 240. Alternatively, however, the data interface 240 can be included in the multidata processor 210 as illustrated in FIGS. 8A to 8F.

Referring to FIG. 9, a camera 220 and a digital broadcast receiver 230 are connected to a multidata processor 210 through a data interface 240 in a 2:1 demultiplexing manner without overlapping of signal lines. To this end, the data interface 240 should include a 2:1 demultiplexer (or 2:1 selector) 241 and needs a GPIO (General Purpose Input/Output) line 243 for controlling the 2:1 selector.

However, in most cases, the camera 220 is inactive while the digital broadcast is received, and the digital broadcast is not received while an image is photographed using the camera 220. In this case, it is possible to select multidata by simply controlling power sources for the camera 220 and the digital broadcast receiver 230, instead of using the 2:1 selector 241. That is, in the camera mode where an image is photographed through the camera 220, the camera 220 is powered on and the digital broadcast receiver 230 is powered off, and in the broadcast reception mode where digital broadcast data is received, the digital broadcast receiver 230 is powered on and the camera 220 is powered off. In this case, output terminals of a powered-off module go to the high-impedance state, preventing influence to output signals of the other module.

A user may simultaneously use the camera 220 and the digital broadcast receiver 230 when occasion demands. In this case, the multidata processor 210 can divide a full screen of the display 150 into two sub-screens and simultaneously display an image signal output from the camera 220 and a digital broadcast signal output from the digital broadcast receiver 230 on the two sub-screens. When interfacing two multidata signals independently processed in the camera 220 and the digital broadcast receiver 230, the data interface 240 is implemented with a 2:1 selector 241, and the output data of the interface 240 is applied to the multidata processor 210 on a time-division basis. That is, the multidata processor 210 receives multidata from two different modules on a time-division basis using the 2:1 selector 241. To this end, the multidata processor 210 should have a function of simultaneously processing two multidata signals.

In the embodiment of the present invention, the selector 241 in the data interface 240 serves as a switching element for selecting an output of the digital broadcast receiver 230 or an output of the camera 220 under the control of the multidata processor 210. In this way, it is possible to physically completely isolate a signal path of the unselected module while processing data output from the selected module.

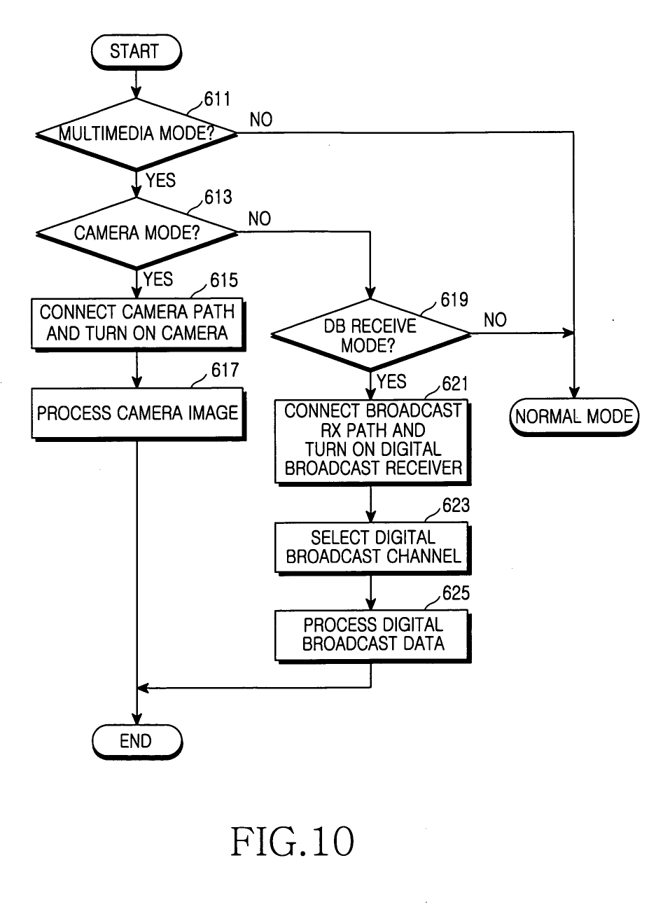

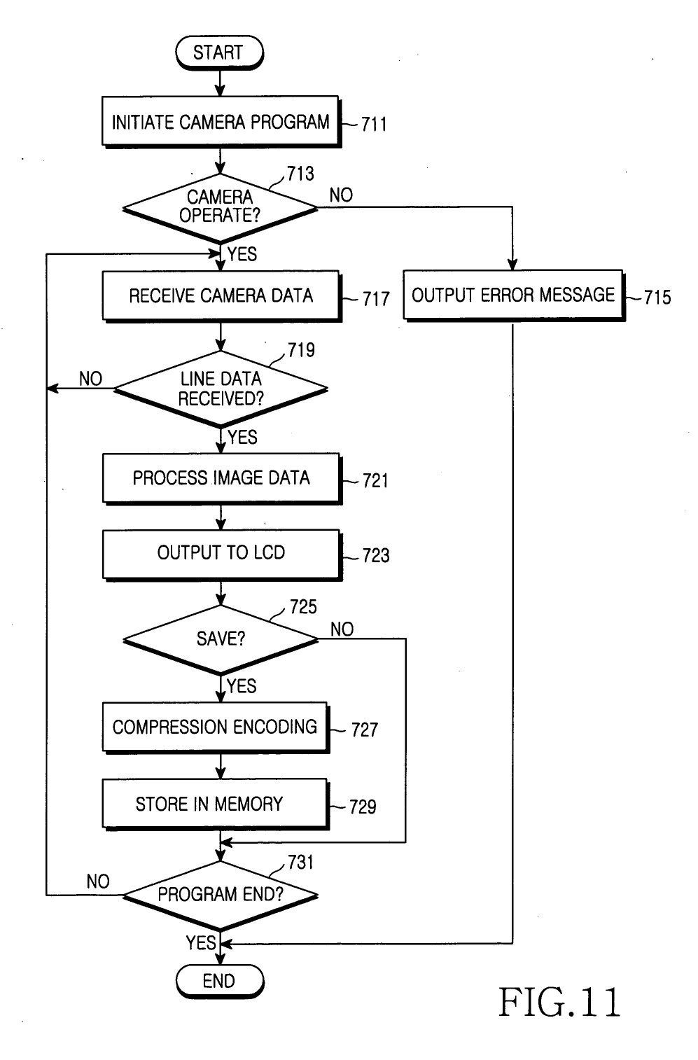

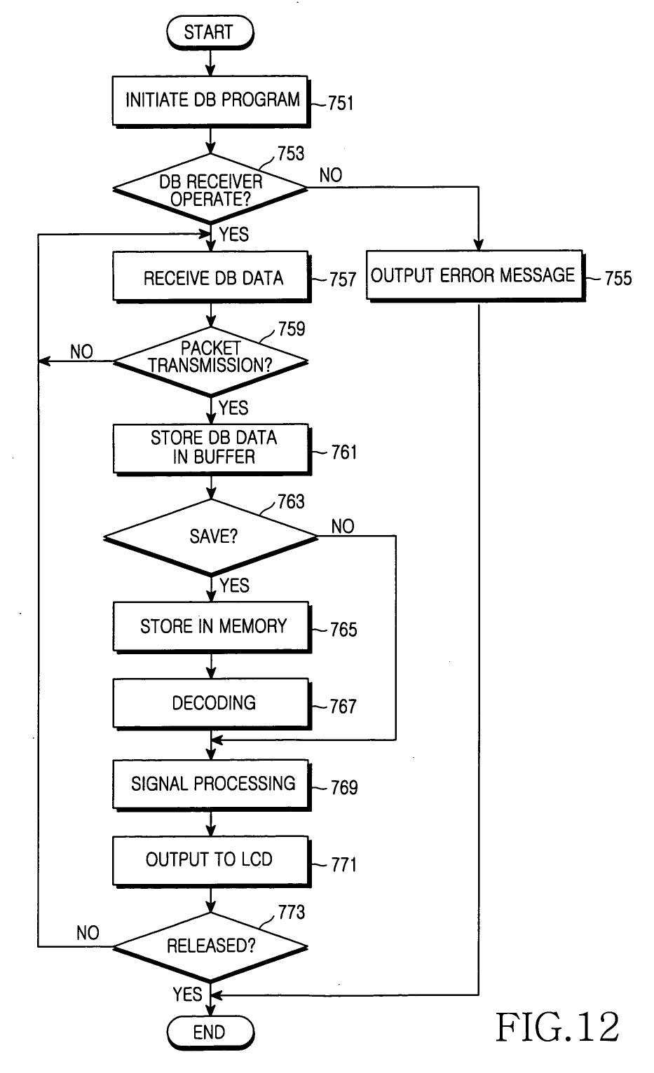

A description will now be made of a procedure for processing outputs of the camera 220 and the digital broadcast receiver 230 in the mobile phone according to an embodiment of the present invention. FIG. 10 is a flowchart illustrating a procedure for processing data output from the camera 220 and the digital broadcast receiver 230 by the multidata processor 210 according to an embodiment of the present invention. FIG. 11 is a flowchart illustrating a detailed procedure for processing image data output from the camera 220 illustrated in FIG. 10, and FIG. 12 is a flowchart illustrating a detailed procedure for processing digital broadcast data output from the digital broadcast receiver 230 illustrated in FIG. 10. It will be assumed in FIGS. 10 to 12 that the data interface 240 is independently implemented outside the multidata processor 210.

Referring to FIG. 10, a user can select the camera mode or the broadcast reception mode using a menu or the key input unit 140. The menu of the mobile phone can include a multidata menu, and the multidata menu can include a camera mode menu and a broadcast reception mode menu. Also, the key input unit 140 can include a camera select key and a digital broadcast select key. If the display 150 includes a touch screen function, the controller 110 and the multidata processor 210 can detect a mode select signal generated from the display 150 with the touch screen.

If a multimedia function is selected through the key input unit 140 or the menu displayed on the display 150, the controller 110 detects the selection of the multimedia function and transfers a right to control the mobile phone to the multidata processor 210. If the camera mode is selected after the multimedia function is selected, the multidata processor 210 detects the selection of the camera mode in steps 611 and 613, and receives the right to control the mobile phone. If the camera mode is selected in step 613, the multidata processor 210 controls in step 615 the selector 241 of the data interface 240 to select an output of the camera 220 and supplies electric power to the camera 220 to drive the camera 220. The multidata processor 210, if it has the structures of FIGS. 8A to 8C, changes outputs of the digital broadcast receiver 230 to the high-impedance state. In step 617, the multidata processor 210 processes image data received from the camera 220.

An operation of processing the camera image in step 617 by the multidata processor 210 is illustrated in FIG. 11

Referring to FIG. 11, if the camera 220 is selected, the multidata processor 210 starts its program for processing an image output from the camera 220 in step 711, and determines in step 713 whether the camera 220 operates in a normal way. If the camera 220 does not normally operate, the multidata processor 210 detects the abnormal operation of the camera 220 in step 713, displays an error message on the display 150 in step 715, and then ends the procedure.

However, if the camera 220 normally operates in step 713, the multidata processor 210 receives image data converted by the data interface 240 per line in step 717. In step 719, the multidata processor 210 receives the image data per line and processes the received image data. The camera image processor 215 processes the image data received from the camera 220. The camera image processor 215, as described above, can include an interface between the camera 220 and the display 150, a scaler, and a color converter. Although the camera image is processed per line in step 719, it can also be processed per frame. In this case, the multidata processor 210 can store the line images buffered by the data interface 240 in a frame buffer thereof.

In step 721, the multidata processor 210 processes the received line image data (or frame image data). The camera image processor 215 performs the image processing in step 721. In the image processing process, the camera image processor 215 scales the photographed image to a screen size of the display 150, performs color conversion for the display 150 (e.g., converts YUV-color signals to RGB-color signals), and zooms in/out the image data at a set zoom ratio if a zoom function is set. Thereafter, in step 723, the multidata processor 210 displays the processed image on the display 150.

If a save function is set in the camera mode, the multidata processor 210 detects the setting of the save function in step 725, and compression-encodes the received image data by JPEG or MPEG using the encoder 217 in step 727. After the compression encoding, the multidata processor 210 stores the compression-encoded image data in the memory 219 in step 729. The image data can be stored together with its file name, and the image data stored can be still image data or moving image data.

If an end command is generated by the user while the multidata processor 210 repeats the foregoing operation of displaying and storing received image data, the multidata processor 210 detects the generation of the end command through the controller 110 in step 731 and inactivates the camera 220.

As described above, if the camera mode is selected, the multidata processor 210 controls the data interface 240 to select outputs of the camera 220, and drives the camera 220. Then the camera 220 generates signals illustrated in FIG. 6A or 6B, and the generated signals are selected by the data interface 240, forming a path connected to the multidata processor 210. The image data output from the camera 220 is converted in a size for the multidata processor 210 (8 bit to 32 bit conversion), and buffered per specific unit (e.g., per line) so that it can be processed in the multidata processor 210.

The multidata processor 210 can process the image data received from the data interface 240 per line or per frame. In the former case, the multidata processor 210 displays the line image data according to the characteristic of the display 150. In the latter case, the multidata processor 210 repeatedly stores the line image data in its frame buffer until frame image data is fully generated, and displays the frame image data according to the characteristic of the display 150. The received image data can be displayed on the display 150 as raw image data without being coded.

In the process of storing image data, the multidata processor 210 performs coding in order to reduce a size of the raw image data. The coding method can follow the MPEG2, MPEG4 or H.264 standard for a moving image, and follow the JPEG standard for a still image. The image data coded in this manner is stored in the memory 219.

Turning back to FIG. 10, if the broadcast reception mode is selected after the multimedia function is selected, the multidata processor 210 detects the selection of the broadcast reception mode in steps 611 to 619, and receives the right to control the mobile phone and controls an operation of the digital broadcast receiver 230. If the broadcast reception mode is selected, the multidata processor 210 controls the selector 241 of the data interface 240 to select outputs of the digital broadcast receiver 230 and supplies electric power to the digital broadcast receiver 230 to drive the digital broadcast receiver 230 in step 621. In step 623, the multidata processor 210 selects a channel designated by the user by providing channel control data to the tuner 233 in the digital broadcast receiver 230. The multidata processor 210, if it has the structures of FIGS. 8A to 8C, changes outputs of the camera 220 to the high-impedance state, releasing an output path of the camera 220. In step 625, the multidata processor 210 processes a broadcast signal for the selected channel, received from the digital broadcast receiver 230.

An operation of processing the received broadcast signal for the selected channel in step 625 by the multidata processor 210 is illustrated in FIG. 12.

Referring to FIG. 12, if the digital broadcast receiver 230 is selected, the multidata processor 210 starts its program for processing a broadcast signal output from the digital broadcast receiver 230 in step 751, and determines in step 753 whether the digital broadcast receiver 230 normally operates. If the digital broadcast receiver 230 does not normally operate, the multidata processor 210 detects the abnormal operation of the digital broadcast receiver 230 in step 753, displays an error message on the display 150 in step 755, and then ends the procedure.

However, if the digital broadcast receiver 230 normally operates, the multidata processor 210 controls the data interface 240 to receive broadcast data output from the digital broadcast receiver 230 and buffer the received broadcast data in step 757. After the data interface 240 fully buffers the broadcast data in a set size, the multidata processor 210 checks whether packet transmission has started in step 759. If it has not, the processor 210 waits for transmission to begin from steps 757 to step 759.

Once packet data transmission begins, the processor 210 stores the digital broadcast data in its buffer and then processes the digital broadcast data per packet in step 761. The demultiplexer 211 and the decoder 213 perform the operation of processing the digital broadcast data in the multidata processor 210.

If a data save function for the digital broadcast receiver 230 is set, the multidata processor 210 detects the setting of the data save function in step 763, and stores the received digital broadcast data in the memory 219 in step 765. If a user desires to record a broadcast signal for a channel selected in the digital broadcast receiver 230, the user can set a channel select function and a channel record function. In this case, the multidata processor 210 stores the coded broadcast signal for the selected channel in the memory 219 without decoding in steps 763 and 765. The broadcast signal stored in the memory 219 can be obtained from the broadcast signal output from the demultiplexer 211.

If a record function is not selected or a normal playback mode is selected, the multidata processor 210 performs an operation of displaying the received digital broadcast signal on the display 150. That is, if the record function is not selected or the normal playback mode is selected, the multidata processor 210 decodes the digital broadcast signal in step 767, scales the decoded broadcast signal according to a size of the display 150 in step 769, and displays the scaled broadcast signal on the display 150 in step 771. In the decoding process of step 767, the multidata processor 210 decodes the broadcast signal compression-coded by the transmission side into its original broadcast signal. In step 769, the multidata processor 210 scales the decoded broadcast signal according to the characteristic of the display 150.

The foregoing operation is repeated until the user releases the broadcast reception mode. If the user releases the broadcast reception mode, the multidata processor 210 detects the release of the broadcast reception mode in step 773, and then ends the procedure.

As described above, if the broadcast reception mode is selected, the multidata processor 210 controls the data interface 240 to select outputs of the digital broadcast receiver 230, and drives the digital broadcast receiver 230 and controls the tuner 233 to select a desired digital broadcast channel. Then the demodulator 235 of the digital broadcast receiver 230 demodulates the selected digital broadcast signal and generates the signals illustrated in FIG. 7A or 7B, and the generated signals are selected by the data interface 240, forming a path connected to the multidata processor 210. The digital broadcast signal output from the digital broadcast receiver 230 is converted in a size for the multidata processor 210 (8 bit to 32 bit conversion), and buffered per specific unit (e.g., per packet) so that it can be processed in the multidata processor 210.

If 1-packet data (1 packet may include 188 bytes in the digital broadcast receiver and a size of the packet is changeable according to a standard for the digital broadcast receiver) is fully buffered in the data interface 240, the multidata processor 210 stores the packet data in this buffer and then decodes the packet after disassembling. If the user sets a record mode for the selected broadcast channel, the multidata processor 210 stores the broadcast signal for the selected broadcast channel in the memory 250 along with its file name. In the process of recording a received broadcast signal, the received broadcast signal can be stored in the memory 250 as it is because the received broadcast signal is a compression-coded signal.

The broadcast signal output from the digital broadcast receiver 230 is decoded per packet before being displayed on the display 150. Therefore, the broadcast channel signal per packet is disassembled into data, and the disassembled data is applied to a video codec and an audio codec according to its characteristic and then decoded into an image signal and an audio signal. Among the decoded signals, an audio signal is applied to the audio processor 125 where it is reproduced, and an image signal is displayed on the display 150 after being scaled up or down. When the decoded broadcast signal can be displayed on the display 150 without scaling, the image scaling operation can be omitted. The foregoing operation is repeated until the user releases the broadcast reception mode. If the user selects another broadcast channel while viewing the current broadcast channel, the multidata processor 210 controls the tuner 233 to reselect the broadcast channel and then repeatedly performs the foregoing operation.

As described above, the camera and the digital broadcast receiver are very similar to each other in terms of a data transmission process and a data format. That is, the camera and the digital broadcast receiver are very similar to each other in terms of an output signal characteristic and transmission timing. However, the differences between the camera and the digital broadcast receiver are illustrated in Table 1.

TABLE 1

| | Digital broadcast receiver | Camera |
|---|---|---|
| Input data format | Compression-coded data | Non-compressed data |
| Data unit | Packet | Frame (or line) |
| Storing in Memory | Stored without | Stored after |
| | compression | compression |
| Displaying | Displaying after decoding | Displaying without |
| | | decoding |

As can be understood from the foregoing description, the mobile phone can process at least two multidata signals with one multidata processor. In the mobile phone, a plurality of multidata signals can be input to the multidata processor through one data interface. When a plurality of input multidata signals are applied to the multidata processor, a type of the input multidata signal can be selected under the control of the multidata processor, and the selected multidata is converted such that it can be processed in the multidata processor, and the converted multidata is buffered in a data size such that it can be processed in the multidata processor.

While the invention has been shown and described with reference to a certain preferred embodiment thereof, it will be understood by those skilled in the art that various changes in form and details may be made therein without departing from the spirit and scope of the invention as defined by the appended claims.

1. A device for processing multidata in a wireless terminal, comprising:
a first data device and a second data device for generating first data and second data according to a first mode select signal and a second mode select signal, respectively;
a data interface connected to the first and second data devices, for interfacing data generated by a data device activated by the mode select signal;
a multidata processor including first and second data processors, for driving a data device selected in response to the mode select signal, and processing data output from the data interface through its associated data processor;
a display for displaying image data output from the multidata processor; and
an audio processor for reproducing audio data output from the multidata processor.

2. The device of claim 1, wherein the first data device is a digital broadcast receiver and the second data device is a camera.

3. The device of claim 2, wherein the data interface comprises:
a selector connected to the first and second data devices, for selecting data output from the first and second data device corresponding to the mode select signal; and
a buffer for buffering data output from the selector in a data size such that the data can be processed in the multidata processor.

4. The device of claim 3, wherein the selector connects a clock, a valid signal, an error signal and data of the digital broadcast receiver to first input terminals, connects a clock, a horizontal sync signal, a vertical sync signal, and data of the camera to second input terminals, selects signals connected to the first input terminals when the first mode is selected, and selects signals connected to the second input terminals when the second mode is selected.

5. The device of claim 3, wherein the buffer buffers input data in a specific data size such that the data can be processed in the multidata processor, and after completion of the buffering, provides a data access request signal to the multidata processor.

6. The device of claim 3, wherein the multidata processor comprises:
a first data processor including a demultiplexer for analyzing, if the first mode is selected, a header of packet data output from the data interface and demultiplexing the packet data into image data and audio data, and a decoder having an image decoder and an audio decoder for decoding the demultiplexed image data and audio data, respectively; and
a second data processor including a scaler for scaling, if the second mode is selected, the data output from the data interface in a size of the display.

7. A device for processing multidata in a wireless terminal, comprising:
a camera for generating image data photographed in a camera mode;
a digital broadcast receiver for generating digital broadcast data received in a broadcast reception mode;
a multidata processor for changing an output of a device unselected in response to a mode select signal to a high-impedance state, driving a device selected in response to the mode select signal, and processing data output from the selected device through a data processor;
a display for displaying image data output from the multidata processor; and
an audio processor for reproducing audio data output from the multidata processor.

8. The device of claim 7, wherein the multidata processor comprises:
a first data processor including a demultiplexer for analyzing, if a first mode is selected, a header of packet data output from the digital broadcast receiver and demultiplexing the packet data into image data and audio data, and a decoder having an image decoder and an audio decoder for decoding the demultiplexed image data and the audio data, respectively; and
a second data processor including a scaler for scaling, if a second mode is selected, the data output from the camera in a size of the display.

9. The device of claim 8, wherein the multidata processor further comprises:
an encoder for compression-encoding the photographed image data if a record mode is selected in the camera mode; and
a memory for storing the encoded data.

10. The device of claim 8, wherein the multidata processor further comprises a memory for storing encoded digital broadcast data output from the demultiplexer if a record mode is selected in the digital broadcast mode.

11. The method of claim 8, wherein a clock, a valid signal, an error signal and data of the digital broadcast receiver are connected to clock, horizontal sync signal, vertical sync signal and data input terminals of the multidata processor, respectively; and,
a clock, a horizontal sync signal, a vertical sync signal and data of the camera are connected to the clock, horizontal sync signal, vertical sync signal and data input terminals of the multidata processor, respectively.

12. The device of claim 8, wherein a clock and data of the digital broadcast receiver are connected to clock and data input terminals of the multidata processor, respectively;
a valid signal of the digital broadcast receiver is connected in common to horizontal and vertical sync signal input terminals of the multidata processor; and,
a clock, a horizontal sync signal, a vertical sync signal and data of the camera are connected to the clock, horizontal sync signal, vertical sync signal and data input terminals of the multidata processor, respectively.

13. The device of claim 8, wherein a clock, a valid signal and data of the digital broadcast receiver are connected to clock, horizontal sync signal and data input terminals of the multidata processor, respectively;
a vertical sync signal input terminal of the multidata processor is connected to a camera reset signal; and,
a clock, a horizontal sync signal, a vertical sync signal and data of the camera are connected to clock, horizontal sync signal, vertical sync signal and data and data input terminals of the multidata processor, respectively.

14. The device of claim 8, wherein a clock, a valid signal, an error signal and data of the digital broadcast receiver are connected to clock, valid signal, error signal and data input terminals of the multidata processor, respectively, and;
a clock, a horizontal sync signal, a vertical sync signal and data of the camera are connected to clock, error signal, valid signal and data input terminals of the multidata processor, respectively.

15. The device of claim 8, wherein a clock and data of the camera are connected to clock and data input terminals of the multidata processor, respectively;
a horizontal sync signal and a vertical sync signal of the camera are connected in common to a valid signal input terminal of the multidata processor; and,
a clock, a valid signal, an error signal and data of the digital broadcast receiver are connected to clock, valid signal, error signal and data input terminals of the multidata processor, respectively.

16. The device of claim 8, wherein a clock, a valid signal, an error signal and data of the digital broadcast receiver are connected to clock, valid signal, error signal and data input terminals of the multidata processor, respectively;
a vertical sync signal input terminal of the multidata processor is connected to a camera reset signal; and,
a clock, a horizontal sync signal and data of the camera are connected to clock, valid signal and data input terminals of the multidata processor, respectively.

17. A method for processing multidata in a wireless terminal including a camera for generating a camera image signal and a digital broadcast receiver for receiving a digital broadcast signal, the method comprising the steps of:
if a camera mode is selected, driving the camera and selecting an output of the camera by switching a data interface;
displaying image data generated from the camera after processing the image data in a screen size of a display;
if a broadcast reception mode is selected, selecting an output of the digital broadcast receiver by switching the data interface, and receiving a digital broadcast signal for a selected broadcast channel by outputting designated broadcast channel control data to the digital broadcast receiver; and
decoding the digital broadcast signal output from the digital broadcast receiver, and displaying the decoded digital broadcast signal after processing the digital broadcast signal in a screen size.

18. The method of claim 17, further comprising, if a save mode is selected in the camera mode, storing the image data in a memory after compression encoding, and if a record mode is selected in the broadcast reception mode, storing the digital broadcast signal in the memory.
